(19) United States
(12) Patent Application Publication
(10) Pub. No.: US 2019/0061709 A1
(43) Pub. Date: Feb. 28, 2019

(54) PARKING BRAKE ASSIST FOR VEHICLES

(71) Applicant: Thomas Jay Bruxvoort, SR., Shelbyville, MI (US)

(72) Inventor: Thomas Jay Bruxvoort, SR., Shelbyville, MI (US)

(21) Appl. No.: 15/684,401

(22) Filed: Aug. 23, 2017

(51) Int. Cl. B60T 7/10

(52) U.S. Cl. CPC B60T 7/102; B60T 13/02

(57) ABSTRACT

Parking brake assists for vehicles providing a reduction in operator discomfort and risk of injury during parking brake deployment or disengagement.

### BACKGROUND OF THE INVENTION

This invention deals with parking brake assists for vehicles helping to reduce user discomfort or injury from deployment or disengagement of a parking brake. The apparatus of this invention reduce user discomfort and physical stress during operation of a parking brake.

Parking brakes can require approximately 30 scale pounds to engage or disengage manually. This inflicts physical stress on an operator's shoulder, elbow, and wrist leading to discomfort or injury. In some vehicles the brake must be engaged and disengaged multiple times over the period of a day's operation. This invention uses innovative ergonomic designs and commonly available materials to reduce operator discomfort and chance of injury.

Prior art patents known to the inventor herein include U.S. Pat. No. 6,634,195, issued to Lenz et al. on Oct. 21, 2003 which discloses an anti-theft device for preventing unauthorized release of the air brakes on a vehicle and U.S. Pat. No. 9,505,392, issued to Boesel et al. on Nov. 29, 2016 that deals with an air brake lock assembly helping to prevent air brakes from being engaged.

None of the above described parking brake devices disclose or show a device that can reduce operator discomfort or injury from parking brake operation.

### THE INVENTION

Thus, what is disclosed and claimed herein is a parking brake assist for vehicles. The parking brake assist for vehicles comprises an elongated rod having a first end, a second end and a center point. The rod has at its first end a gripping cover. At its second end the rod has a rotatable mechanism comprising a mounting bracket for mounting this end onto a dashboard of a vehicle having parking brakes. The mounting bracket comprises a flat plate having a first and a second end. Each end has an opening therethrough to facilitate fastening to a vehicle dashboard. The flat plate also has two spaced-apart stanchions, with each stanchion having an opening therethrough near a top thereof for maintaining an insertable round bar therein with a retainer at each end. The second end of the elongated rod has a rolled configuration that is mounted on the insertable round bar and rotatable around it. There is also a claw mechanism mounted near the center point of the elongated rod and on its back configured to insert on a back side of a brake button control knob for a braking system on a vehicle.

Another embodiment of this invention is an elongated rod having a first end and a second end. On its first end there is mounted a rotatable knob. Its second end is mounted to a connector consisting of a splined screw that is itself mounted to a control rod for a braking system for a vehicle. The splined screw is rigidly mounted on a mounting bracket that is mountable on the dashboard of a vehicle having a braking system.

Yet another embodiment of this invention is a curved elongated rod having a first end and a second end. The first end is rigidly attached to a control rod for a brake system for a vehicle. The second end has a handle mounted to it. This handle is a standard parking brake button.

### BRIEF DESCRIPTION OF THE DRAWINGS

FIG. 1 is an illustration of a lever-based brake assist apparatus showing its context when installed.

FIG. 2 is a full top view of the lever-based brake assist apparatus.

FIG. 3 is a full side view of the lever-based brake assist apparatus showing how the invention interacts with a representative parking brake button (not a part of this invention).

FIG. 4 is a detailed partial side view showing a rolled configuration end of the rod of the lever-based brake assist apparatus intended for its rotatable mounting onto a round bar.

FIG. 5 is an illustration of a splined screw-based brake assist apparatus showing its context when installed.

FIG. 6 is a full top view of the splined screw-based brake assist apparatus.

FIG. 7 is a full side view of the splined screw-based brake assist apparatus showing how the invention interacts with a representative parking brake control rod (not part of this invention).

FIG. 8 is an illustration of a rod-based brake assist apparatus showing its context when installed in a vehicle.

FIG. 9 is a side view of the rod-based brake assist apparatus showing how the invention interacts with a representative parking brake control rod (not part of this invention).

### DETAILED DESCRIPTION OF THE INVENTION

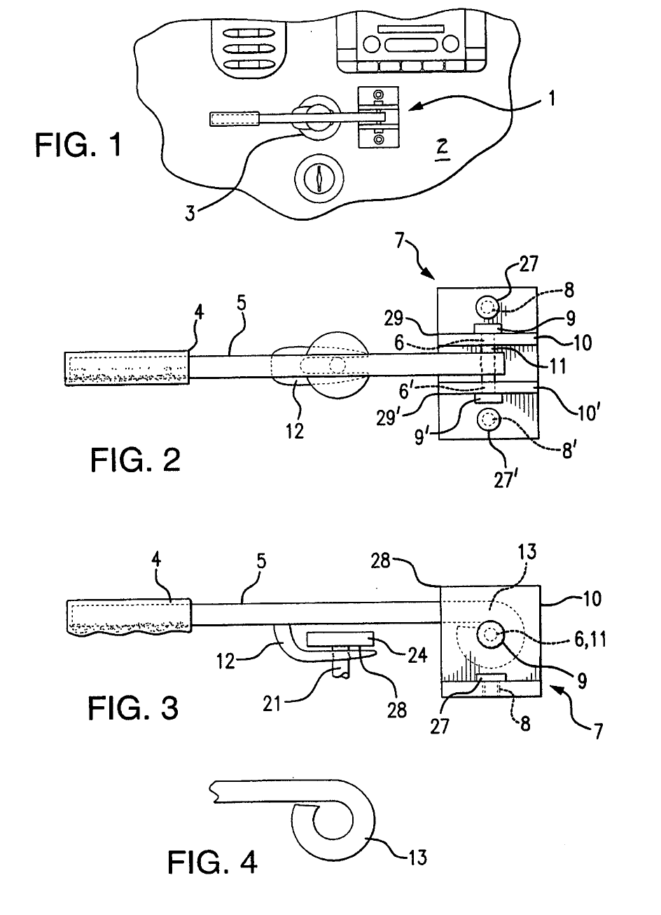

FIG. 1 shows an illustration of a lever-based brake assist apparatus 1 mounted onto the dashboard 2 (the dashboard 2 is not a part of this invention) of a vehicle. The apparatus is intended to be mounted to the dashboard of a vehicle (not part of this invention) such that it may effectively be used to engage or disengage a parking brake by means of a parking brake button 3 (not a part of this invention).

FIGS. 2 and 3 show full top and side views of the apparatus, respectively, of the lever-based brake assist apparatus. The apparatus comprises an elongated rod 5, which may also be referred to alternatively as a lever, having at one end a grip 4 that may be manufactured of any suitable material, most preferably of foam, rubber, or plastic. The grip 4 can have an ergonomic design to facilitate user comfort. The rod 5 is preferably 4-10 inches in length, more preferably 5-8.5 inches, most preferably 6-7 inches.

The rod 5 is mounted by a rotatable mechanism 13 to a bracket 7. The bracket 7 is flat plate with openings 8 at each end intended to be used for securing the bracket 7 to a vehicle dashboard. The means of securing the bracket 7 to the dashboard is preferably by means of shoulder bolts 27.

The bracket 7 has two stanchions 10 each having an opening 6 near the top 28. These openings 6 maintain an insertable round bar 11 therein having a retainer 9 at each end 29.

Detailed in FIG. 4 which is a detailed partial side view of a rolled end 13 of the rod 5. This rolled end 13 serves to mount the rod 5 in a rotatable manner to the bracket 7 by means of the round bar 11.

A claw mechanism 12 is mounted near the center point of the rod 5. This claw mechanism 12 is configured to insert on the back side 28 of a brake button control knob 24 for a braking system on a vehicle. This serves to secure the lever 5 to the control knob 24 so that the assist apparatus 1 may effectively engage or disengage the parking brake.

The rod 5, claw 12, and bracket 7, 9, 10, 11 may be manufactured of any suitably strong material, such as metal. Preferably the metal is selected from steel and aluminum, steel being the most preferred.

The lever mechanism 1 significantly reduces the physical force necessary to engage or disengage a parking brake, thereby reducing potential for user injury or discomfort.

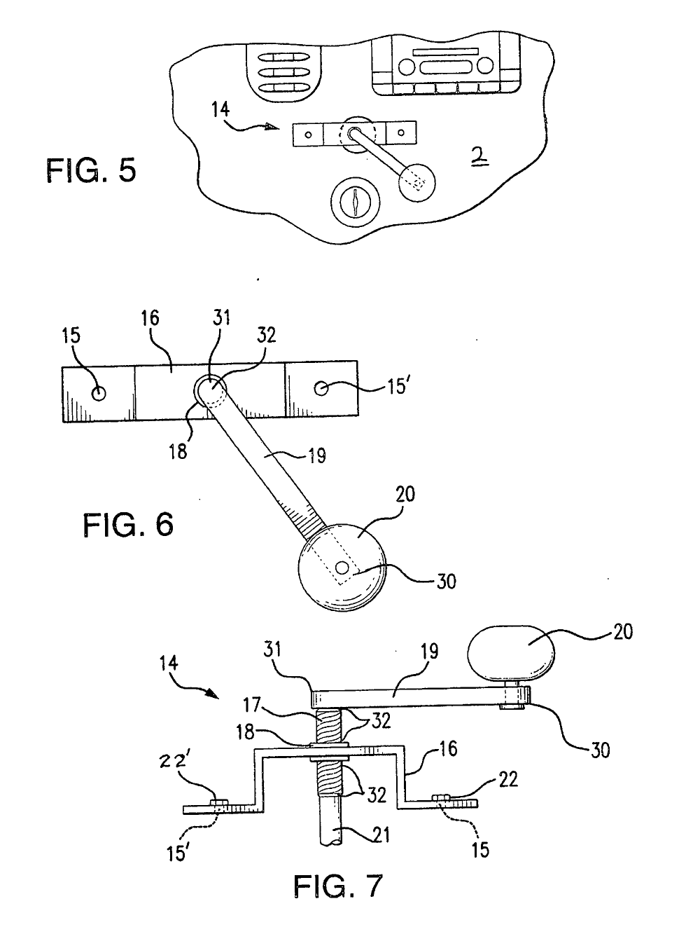

FIG. 5 shows a splined screw-based brake assist apparatus 14 mounted onto the dashboard 2 (the dashboard 2 is not a part of this invention) of a vehicle. The apparatus 14 is intended to be mounted to the dashboard of a vehicle such that it may effectively be used to engage or disengage a parking brake by means of its control rod 21 (not a part of this invention).

FIGS. 6 and 7 show full top and side views of the apparatus 14, respectively. The apparatus consists of an elongated rod 19 having a rotatable knob 20 mounted on one end 30. The rod 19 is preferably 4-10 inches in length, more preferably 5-9 inches, and most preferably 6-8 inches. The opposite end 31 is mounted onto a connector 32 consisting of a splined screw 17 rigidly mounted to a control rod 21 for a braking system for a vehicle. The splined screw 17 is rigidly mounted, preferably by means of a fixed nut 18, onto a mounting bracket 16.

The mounting bracket 16 is mountable on the dashboard 2 of a vehicle having a braking system. The bracket 16 may be mounted to a dashboard 2 preferably by means of shoulder bolts 22. Each end of the bracket 16 has a hole 15 to help facilitate mounting of the bracket to a vehicle dashboard 2.

The mounting bracket 16 and its associated components 18 22, rod 19, and connector 32 are manufactured of any suitably strong material, such as metal. Preferably the metal is selected from steel and aluminum, steel being the most preferred.

This apparatus 14 serves to reduce the physical force necessary to be exerted on the part of a user in order to effectively engage or disengage a vehicle parking brake. This reduces risk of operator injury or discomfort resulting from parking brake operation.

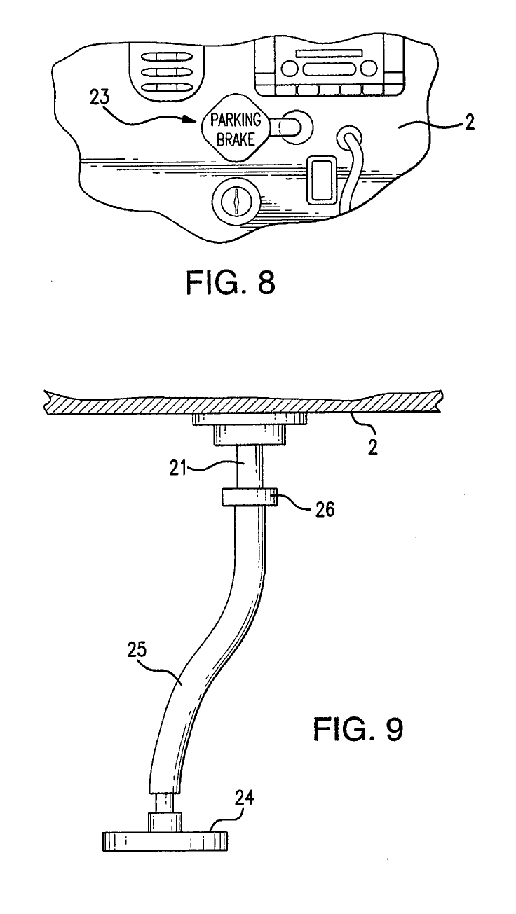

FIG. 8 shows a rod-based brake assist apparatus 23 installed on the dashboard 2 of a vehicle. The apparatus 13 is intended to be installed such that it may effectively be used to engage or disengage a parking brake by means of its control rod 21.

FIG. 9 shows a full side view of the apparatus 23. The apparatus 23 consists of a curved elongated rod 25 rigidly attached 26 to a control rod 21 for a brake system on a vehicle. The rod 25 and attachment mechanism are manufactured of any suitably strong material, such as metal. Preferably the metal is selected from steel and aluminum, steel being the most preferred. The rod is preferably 4-12 inches in length, more preferably 5-10 inches in length, and most preferably 6-9 inches in length.

The rod 25 has mounted on the end opposite the vehicle dashboard 2 a standard parking brake button 24. The length and curve of the rod 25 are so designed as to to allow for the parking brake button 24 to be positioned in such a manner as to make it more convenient for an operator to engage or disengage the parking brake. This helps to reduce operator discomfort or injury by reducing the distance one must reach in order to effectively engage or disengage a parking brake.

What is claimed is:

1. A parking brake assist for vehicles, said PBA comprising
an elongated rod having a first end, a second end and a center point;
said rod having at said first end, a gripping cover;
said rod having on said second end a rotatable mechanism, said mechanism comprising a mounting bracket for mounting said second end on a dashboard of a vehicle having parking brakes, said bracket comprising a flat plate having a first and a second end, each said end having an opening therethrough; said flat plate having two, spaced-apart stanchions, each said stanchion having an opening therethrough near a top thereof;
said stanchion openings maintaining an insertable round bar therein, said round bar having a retainer at each end;
said second end of said elongated rod having a rolled configuration that is mounted on said insertable round bar and rotatable around said insertable round bar;
a claw mechanism mounted near said center point and on a back of said elongated rod, said claw configured to insert on a back side of a brake button control knob for a braking system on a vehicle.

2. A parking brake assist for vehicles, said PBA comprising:
an elongated rod having a first end and a second end;
said first end having a rotatable knob mounted thereon;
said second end being mounted on a connector consisting of a splined screw, said splined screw being mounted to a control rod for a braking system for a vehicle,
said splined screw housing being rigidly mounted on a mounting bracket, said mounting bracket being mountable on the dashboard of a vehicle having a braking system.

3. A parking brake assist for vehicles, said PBA comprising:
a curved elongated rod having a first end and a second end, said first end rigidly attached to a control rod for a brake system for a vehicle;
said second end having mounted thereon a handle, wherein said handle is a standard parking brake button.
